(19) United States
(12) Patent Application Publication
(10) Pub. No.: US 2006/0105073 A1
(43) Pub. Date: May 18, 2006

(54) Press

(76) Inventors: Wolfgang Hogenkamp, Remscheid (DE); Ulrich Reineke, Overath (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/512,538

(22) PCT Filed: Apr. 17, 2003
(86) PCT No.: PCT/EP03/04050

§ 371 Date: Dec. 19, 2005

(30) Foreign Application Priority Data
Apr. 25, 2002 (DE) 102 18 633.2

(51) Int. Cl. B28B 17/00

(52) U.S. Cl. 425/150

(57) ABSTRACT

The press is used in the production of friction linings for brake or clutch linings and comprises at least one press station which is provided with a press mould (15, 16, 18) and a pressure ram (19) co-operating therewith. Spindle drives (4, 10) are used for generating relative movements and clamping and closing forces between the mould and the pressure ram, said drives comprising respectively a spindle (5, 12) and an auxiliary spindle nut (7, 13). The relative rotation thereof is driven by an auxiliary electric motor (6, 11), whereby power transmitting rolling bodies embodied in the form of threaded rollers or spherical-shaped elements are respectively arranged between the spindle and the spindle nut. A low-friction area, which can be controlled in a highly accurate path and force dependent manner, is obtained in order to provide a wide distribution of force and ensure dimensional accuracy of the friction linings in addition to an exact adjustment of porosity and compressibility.

The invention relates to a press for the production of resin-bonded pressed parts, particularly for friction linings for brake linings or clutch linings, with at least one press station having a press mould and a press ram co-operating therewith, and with at least one linear drive to generate relative movements and clamping and closing forces between the mould and the press ram.

Presses of this type which are known in the art have as the linear drive a hydraulic piston machine which is supplied by a hydraulic system. It has been found that the control of such a liner drive is capable of improvement.

The object of the invention therefore is to improve the drive control of the press.

In order to achieve this object the press referred to in the introduction is characterised according to the invention in that the linear drive is constructed as a spindle drive with at least one spindle and an appertaining spindle nut, the relative movement of which serves to generate the relative movement and the clamping and closing forces, and can be driven by a motor, particularly an electric motor, wherein power-transmitting roller bodies are preferably disposed between the spindle and the spindle nut.

Thus the invention abandons the hydraulic drive system and adopts a mechanical, particularly electromechanical drive.

It should be mentioned as a significant advantage that the mechanical spindle drive makes it possible to distribute force over a wide range without additional outlay. Hydraulic systems are based here on cylinders of different sizes and pressure stages of the hydraulic system which are also of different sizes, and these have complex connections. Also by means of the spindle drive high travel speeds can be readily combined with high clamping forces, the travel speed being controlled by way of the motor speed. Also for this hydraulic systems require cylinders of different sizes and/or different pressure ranges (low pressure for rapid low-force processes, high pressure for application of the actual pressing force). Furthermore the spindle drive allows fine control, which cannot be achieved in a hydraulic processing machine because on starting of that machine a breakaway torque has to be overcome and the frictional resistances of seals and hydraulic system components alter over the operating times.

It should also be emphasised that the spindle drive operates with a higher overall efficiency than a hydraulic drive system. The flow losses of the hydraulic pump and of the hydraulic system connected downstream thereof do not occur. Also the spindle drive does not require the permanent operation which is necessary in a hydraulic system. In the latter case the pump must also maintain the system pressure even when no power is called for. Finally, in a hydraulic system considerable friction resistances have to be overcome between the piston seals and the cylinder. The transmission of power between the spindle nut and the spindle, on the other hand, is extremely low-friction, particularly when interposed roller bodies are used.

Hydraulic systems are naturally associated with a certain leakage. The escaping fluids are harmful to the environment and must be collected (oil sump) and possibly disposed of as hazardous waste. In addition, if these fluids come into contact with the friction linings they have an extremely disadvantageous effect on the quality thereof. They can even lead to a safety risk. For these reasons hydraulic assemblies are usually installed below the production tools. However, it is disadvantageous in this case that these components are to a substantial extent exposed to the aggressive material dust particles. These dust particles can penetrate through the seals into the hydraulic system and can cause damage by increasing the wear. On the other hand the spindle drive can be shielded effectively against the escape of any lubricant.

Above all the spindle drive has the great advantage of a control means which can be produced very simply and operates very exactly as a function of the path. The compression paths can be adjusted very precisely. In the event of shrinkage of the lining travel can be continued or the clamping position can be maintained. In this way friction lining presses achieve the level of precision of CNC-controlled machine tools. Also it is possible to change over without problems from control as a function of path to control as a function of force, in complete contrast to hydraulic systems which require a costly electrohydraulic control for this. In the spindle drive fine control of the paths and forces is readily possible. Apart from the precision of positioning a high repetition precision (2.5/100 mm) is ensured. In this way friction linings can be produced in a very narrow compressibility band such as is required in particular for further electromechanical braking systems in motor vehicles. The force-oriented and path-oriented fine control also makes precise adjustment of the porosity possible.

The high degree of distribution of force leads, as mentioned, to narrow tolerance ranges and thus to a correspondingly low reject rate. It makes possible rapid shaping under high force and also a fine-metered change of path under minimal changing force requirements. In this case individual tailoring to the particular product and to the particular product situation is possible. The power and path adjustment can be dynamic. Since the control, drive and sensor systems function on an electrical basis, direct communication is possible without a detour via the hydraulic form of energy.

The mechanical drive operates with a few simple components. Since no waste heat produced by flow losses needs to be removed, it does not require any corresponding cooling system. Also other auxiliary assemblies are omitted, so that a compact construction can be achieved which does not require much space. Also the maintenance costs are low.

Finally, it should be mentioned that the high travel speed which can be achieved by way of the spindle drive makes short cycle times possible. Nevertheless the press operates quietly without the need for soundproofing.

A particularly simple control of the spindle drive is made possible by co-ordinating a force sensor with the press mould or co-ordinating a sensor for the angle of rotation with the motor driving the spindle. When synchronous motors are used the supplied pulses can be registered by way of the control means in order to travel predetermined paths specifically and reproducibly.

Basically the possibility exists of driving either the spindle or the spindle nut by way of the motor. A particularly advantageous embodiment is characterised in that the spindle is connected to the motor and that the spindle nut actuates a push and pull element which generates the relative movements and the clamping and closing forces. The motor is preferably flanged directly onto the spindle, which leads to a particularly compact construction.

As an alternative embodiment it is proposed that the spindle nut has a toothing which engages with a drive gear which can be rotated by the motor.

For the toothing of the spindle nut and the construction of the drive gear basically any pairing of gears may be considered. However, a preferred embodiment is characterised in that the spindle nut bears a bevel gearing and that the drive gear is constructed as a bevel gear. This makes a particularly compact design possible, since the axles of the gears cross. The latter also applies when the spindle nut bears a worm gearing and the drive gear is constructed as a worm. A further advantage of this design is that the drive is self-locking, so that an additional brake can be dispensed with.

The roller bodies disposed between the spindle and the spindle nut not only make low-friction transmission of force possible but also allow the generation of higher clamping forces. This applies in particular when the roller bodies are constructed as threaded rollers (planetary roller thread drive). A construction as balls may also be considered, although guiding thereof is costly. Also the force-transmitting screw threads must be of coarser construction than in the case of threaded rollers.

Those movements which serve for degassing of the friction material are also included in the relative movements between the mould and the press ram. Moreover, a further advantageous feature resides in the fact that additional functions of the friction lining press, such as ejection of the lining, lifting the lining out of profile parts for degassing, etc., can be actuated by the spindle drive or by additional motor-driven spindle drives.

The invention will be explained in greater detail below with reference to a preferred embodiment in connection with the appended drawings, in which:

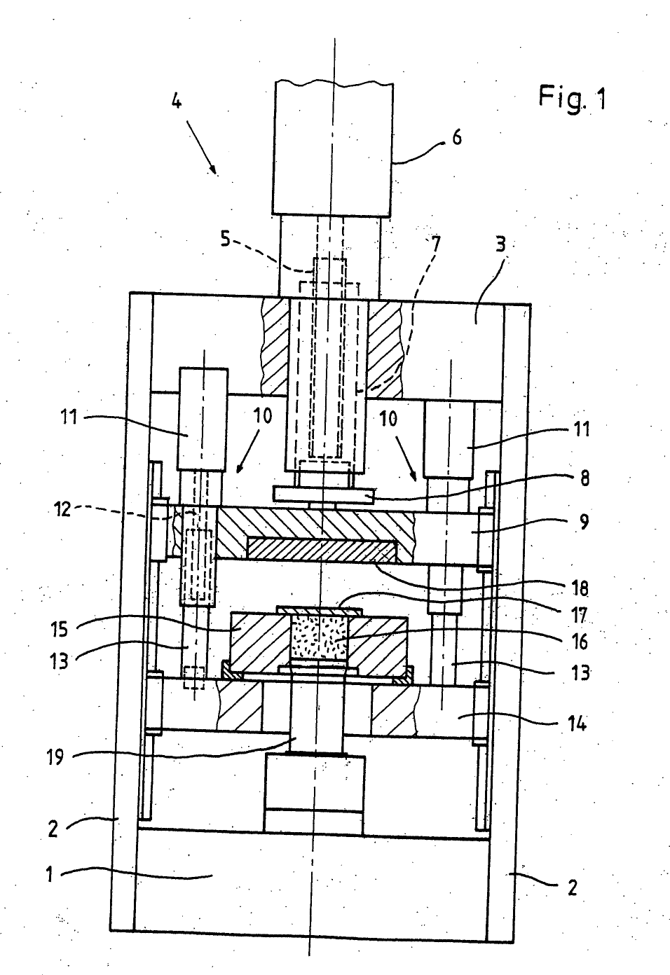

FIG. 1 shows a partially cut-away front view of a friction lining press according to the invention.

The friction lining press according to FIG. 1 has a base 1, a vertical frame comprising two side parts 2 and an upper support 3 which closes off the frame.

A spindle drive 4 is fixed on the upper support 3. It has a spindle 5 which is connected to an electric motor 6 and is driven thereby. A spindle nut 7 runs on the spindle and is connected via a push and pull element 8 to an upper crosspiece 9. Force-transmitting roller bodies in the form of balls or threaded rollers are disposed between the spindle 5 and the spindle nut 7 and ensure low-friction operation.

The crosspiece 9 is guided in the side parts 2 of the frame and is moved in the vertical direction by the spindle drive 4. On the upper crosspiece there are fixed two spindle drives 10 of similar construction which each have an electric motor 11, a spindle 12 connected thereto and an appertaining spindle nut 13. The spindle drives 10, which also operate with low friction with force-transmitting roller bodies interposed, are connected to a lower crosspiece 14 which is also guided in the side parts 2 of the frame and can be moved upwards and downwards relative to the upper crosspiece 9 by the spindle drives 10.

A profile part 15 of a two-part press mould is disposed on the lower crosspiece 14. The profile part 15 forms a mould cavity which is filled with friction material 16 and is covered by a friction lining support plate 17.

A stationary press ram 19 projects into the mould cavity.

The second part of the press mould is formed by a mirror plate 18 which is mounted in the upper crosspiece 9.

FIG. 1 shows the position of the friction lining press before the start of the pressing operation. This operation is started by lowering of the upper crosspiece 9 with simultaneous actuation of the spindle drives 4 and 10, the lower crosspiece 14 maintaining its position. As soon as the mirror plate 18 of the upper crosspiece 9 has touched the support plate 17 the two spindle drives 10 generate the necessary closing force in order to clamp the two parts of the press mould together. Continuation of the actuation of the spindle drive 4 generates the actual pressing force with which the closed press mould is moved downwards against the stationary press ram 19. The press ram travels into the mould cavity and compresses the friction material.

In the course of the pressing operation it may be necessary to vent the friction material. This is achieved by actuation of the spindle drives 10 in order to move the lower crosspiece 14 and thus the profile part 15 of the press mould downwards. The upper crosspiece 9 does not join in this movement, that is to say the mirror plate 18 still holds the support plate 17 in contact with the friction material 16. In this case the pressing force can remain the same or can be reduced in order then, after the profile part 15 of the press mould has been moved upwards again, to be increased again, possibly beyond the previously set value.

The electric motor-driven spindle drives 4 and 10 which are used according to the invention make it possible to travel the necessary paths quickly and very exactly. The control may be effected as a function of the path and/or the force, and with the utmost exactitude. The highest degree of precision is achieved, both with regard to the dimensions and with regard to the porosity and the compressibility of the friction linings.

Within the scope of the invention it is certainly possible to make modifications. Thus instead of the illustrated motor-driven spindle drives it is possible to use such drives in which the spindles are connected to the electric motors with a gear interposed. It is then possible if need be to dispense with the reversibility thereof. The possibility also exists of driving the spindle nuts, in which case the spindles take care of the transmission of force. In this case then spindle nuts can be provided with toothings into which the driven drive gears engage, be they bevel gears or worm gears. In any case force-transmitting roller bodies can be disposed between the spindles and the spindle nuts in order to ensure low-friction driving. The efficiency is correspondingly high, which contributes to an increasing the existing favourable overall efficiency of the press. In the case of balls the self-limiting of the drive is retained.

The possibility also exists of letting the pressing force act on the press ram whilst the press mould is held immobile. In this case, and also in the case illustrated in FIG. 1, the mould cavity can also be situated below the press ram.

The friction lining press shown in FIG. 1 has only one single press station. An arrangement of a plurality of press stations one behind the other is equally possible.

Instead of the preferred electric motors other motors may also be considered, e.g. hydraulic motors.

The principal field of application of the invention is the production of friction linings for brake linings or clutch linings. Accordingly the description relates predominantly to friction lining presses. However, it should be emphasised that the invention is applicable to the processing of any resin-bonded pressing materials, for example to the production of carbon brushes for electric motors.

The friction lining press makes it possible not only to produce friction linings alone but also simultaneously to join the friction linings to appertaining support plates, possibly with an underlayer interposed.

Above all, the friction lining press is suitable for a method in which shaping, curing, venting and scorching are carried out in one single step. After the closure of the mould the shaping is carried out, possibly with simultaneous heating, i.e. it is operated with a very high pressure. Then the curing takes place, the pressure being reduced and the temperature increased. The pressure can be varied as a function of the force and/or the path. The moulding is simultaneously vented by movement of the movable profile part of the press mould downwards without the pressure between the mirror plate and the press ram having to be removed. The trapped air, the gases produced during setting of the rein and the steam generated are able to escape radially from the moulding in a favourable manner. The heat for the curing is generated within the friction lining, utilising the conductivity of the material. When the profile part is lowered the mirror plate and the press ram are isolated from one another. Thus an electric current flow through the friction lining can be generated between these parts. This is carried out by the use of a matrix of electrodes on the friction side of the lining. The electrodes have alternately opposing polarities, so that current flows are simultaneously generated in the close range parallel to the friction surface. These current flows effect the simultaneous scorching.

1-10. (canceled)

11. A Press for the production of resin-bonded pressed parts, comprising:
at least one press station having an upper and a lower crosspiece as well as a press mould and a press ram co-operating therewith, and
linear drives to generate relative movements and closing forces between the crosspieces and also to generate relative movements and clamping forces between the press mould and the press ram,
wherein
the linear drives are constructed as spindle drives each having at least one spindle and an appertaining spindle nut, the relative movement of which serves to generate the relative movement and the clamping and closing forces, and can be driven by a motor, particularly an electric motor, and
force-transmitting roller bodies are preferably disposed between the spindle and the spindle nut.

12. The Press of claim 11, comprising a control means for the motor, said control means operating selectively as a function of the force and/or of the path.

13. The Press of claim 12, wherein the control means has a force sensor co-ordinated with the press mould and a sensor for the angle of rotation co-ordinated with the spindle or with the motor driving the spindle.

14. The Press of claim 11, wherein the spindle is connected to the motor and wherein the spindle nut actuates a push and pull element which generates the relative movements and the clamping and closing forces.

15. The Press of claim 11, wherein the spindle nut bears a toothing which engages with a drive gear which can be rotated by the motor.

16. The Press of claim 15, wherein the spindle nut bears a bevel gearing and wherein the drive gear is constructed as a bevel gear.

17. The Press of claim 15, wherein the spindle nut bears a worm gearing and the drive gear is constructed as a worm.

18. The Press of claim 11, wherein the force-transmitting roller bodies disposed between the spindle and the spindle nut are constructed as threaded rollers.

19. The Press of claim 11, wherein the force-transmitting roller bodies disposed between the spindle and the spindle nut are constructed as balls.

20. The Press of claim 11, wherein additional functions of the friction lining press, such as ejection of the lining, lifting the lining out of profile parts for degassing, etc., can be actuated by the spindle drive or by additional motor-driven spindle drives.

21. The Press of claim 1, for friction linings for brake linings or clutch linings,
